(19) United States
(12) Patent Application Publication
(10) Pub. No.: US 2014/0164054 A1
(43) Pub. Date: Jun. 12, 2014

(54) OPERATING A SERVER COMPUTER

(71) Applicant: Craig Swallow, South Yorkshire (GB)

(72) Inventor: Craig Swallow, South Yorkshire (GB)

(73) Assignee: Connexion2 Limited, South Yorkshire (GB)

(21) Appl. No.: 14/118,049

(22) PCT Filed: May 15, 2012
(86) PCT No.: PCT/GB2012/051076

§ 371 Date: Feb. 10, 2014

(30) Foreign Application Priority Data
May 16, 2011 (GB) 1108195.7

(51) Int. Cl. G06Q 10/06

(52) U.S. Cl. CPC G06Q 10/0635
USPC 705/7.28

(57) ABSTRACT

A method of operating a server computer system, which is configured to communicate with a plurality of remote devices. The remote devices are operated by lone workers who are exposed to hazardous environments. The method comprises receiving location data identifying a work location from a transmitting remote device, receiving hazard data relating to hazards in the vicinity of said work location, processing said hazard data to produce an assessment of risk, and conveying an indication of said assessment of risk to a receiving remote device.

### CROSS-REFERENCE TO RELATED APPLICATIONS

This application is a 35 U.S.C. 371 National Phase Application of PCT/GB2012/051076 filed on May 12, 2012, which claims priority to United Kingdom Patent Application No. GB 1108195.7 filed on May 16, 2011, the content of which are incorporated herein in their entirety.

### BACKGROUND OF THE INVENTION

1. Field of the Invention

The present invention relates to the method of operating a server computer system configured to communicate with a plurality of remote devices, in which each said remote device is operated by a respective lone worker exposed to hazardous environments.

2. Description of the Related Art

A device for use by lone workers exposed to hazardous environments is disclosed in U.S. Pat. No. 7,412,264, assigned to the present applicant. The disclosed security device provides a discreet mechanism whereupon it is possible for a lone worker, exposed to danger, to be able to contact a control station, whereafter appropriate action may be taken. However, to install such devices, there is an initial cost, followed by a running cost in order to ensure that a control station is functional at all times. In some situations, employers may be reluctant to deploy solutions of this type due to the additional costs.

### BRIEF SUMMARY OF THE INVENTION

According to an aspect of the present invention, there is provided a method of operating a server computer system configured to communicate with a plurality of remote devices, in which said remote devices are operated by lone workers exposed to hazardous environments, said method comprising the steps of: receiving location data identifying a work location from a transmitting remote device; receiving hazard data relating to hazards in the vicinity of said work location; processing said hazard data to produce an assessment of risk; and conveying an indication of said assessment of risk to a receiving remote device.

### BRIEF DESCRIPTION OF THE DRAWINGS

FIG. 1 shows an environment for operating a server computer system;

FIG. 2 shows operations performed by the server system identified in FIG. 1;

FIG. 3 shows protocol diagram identifying procedures performed within the environment of FIG. 1;

FIG. 4 shows a schedule prepared by a lone worker;

FIG. 5 illustrates procedures for performing risk evaluation;

FIG. 6 shows indications of risk being conveyed back to a lone worker;

FIG. 7 illustrates risk calculation procedures;

FIG. 8 shows a modified schedule to be monitored by the server system;

FIG. 9 shows an example of procedures for taking action when a lone worker may be in danger; and

FIG. 10 shows alternative procedures for taking action when a lone worker may be in danger.

### DETAILED DESCRIPTION OF EXAMPLE EMBODIMENTS

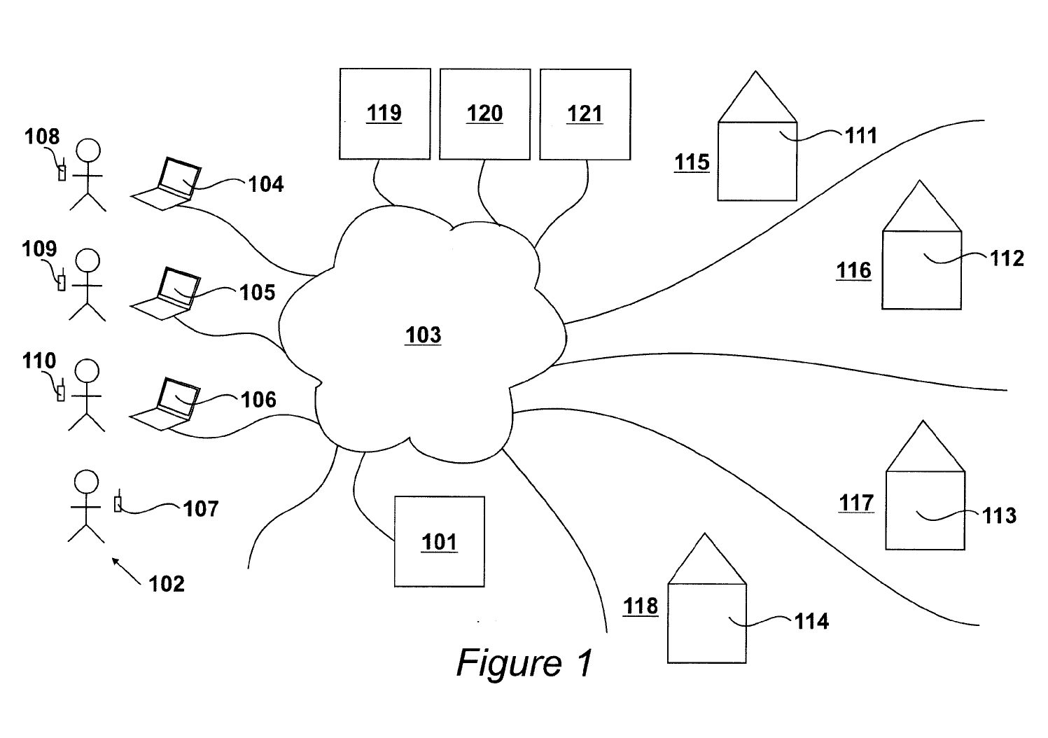

### FIG. 1

An environment for operating a server computer system 101 configured to communicate with a plurality of remote devices is illustrated in FIG. 1. The remote devices are operated by lone workers 102 who are exposed to hazardous environments. These hazardous environments may be present due to a lone worker (medical or social etc) visiting a patient with a history of violence or mental problems for example. Alternatively, the patient themselves may not be the cause of potential hazards but the location being visited may present external hazards due to a history of crime for example. Furthermore, other external hazards may be present due to transient conditions. Details of these hazards may be provided from external sources or alternatively, data may have been created by the lone workers themselves based on previous interactions. In addition, data may have been received from other communities of lone workers.

The server computer system 101 communicates with remote devices via a network 103, such as the internet. Each lone worker (102) is provided with a transmitting remote device 104, 105, 106 and 107. Each lone worker is also provided with a receiving remote device 108, 109 or 110. In an embodiment, a transmitting remote device 104 is a personal computer or laptop computer running internet browser software. The receiving device 108 may be a cellular mobile telephone, or the transmitting remote device.

As an alternative to having a personal computer and a mobile telephone, device 107 may be a portable computing device, such as a smart phone or a cellular enabled touch tablet.

In this example, four locations are identified, being location 111, location 112, location 113 and location 114. These locations may be identified to the server system 101 as locations where a lone worker will perform a work function. For the purposes of this illustration, it is also assumed that location 111 is present within region 115, location 112 is present within region 116, location 113 is present within region 117 and location 114 is present within region 118.

The environment also includes a first source of hazard data 119, a second source of hazard data 120 and a third source of hazard data 121. Thus, the server system 101 receives hazard data relating to hazards in the vicinity of the work locations from sources 119, 120, 121 and from the lone workers themselves via respective transmitting devices 104, 105 and 107.

At the server system 101 the hazard data is processed to produce an assessment of risk. An indication of this assessment of risk is conveyed from the server system 101 to the receiving remote devices 108, 109, 110 and 107.

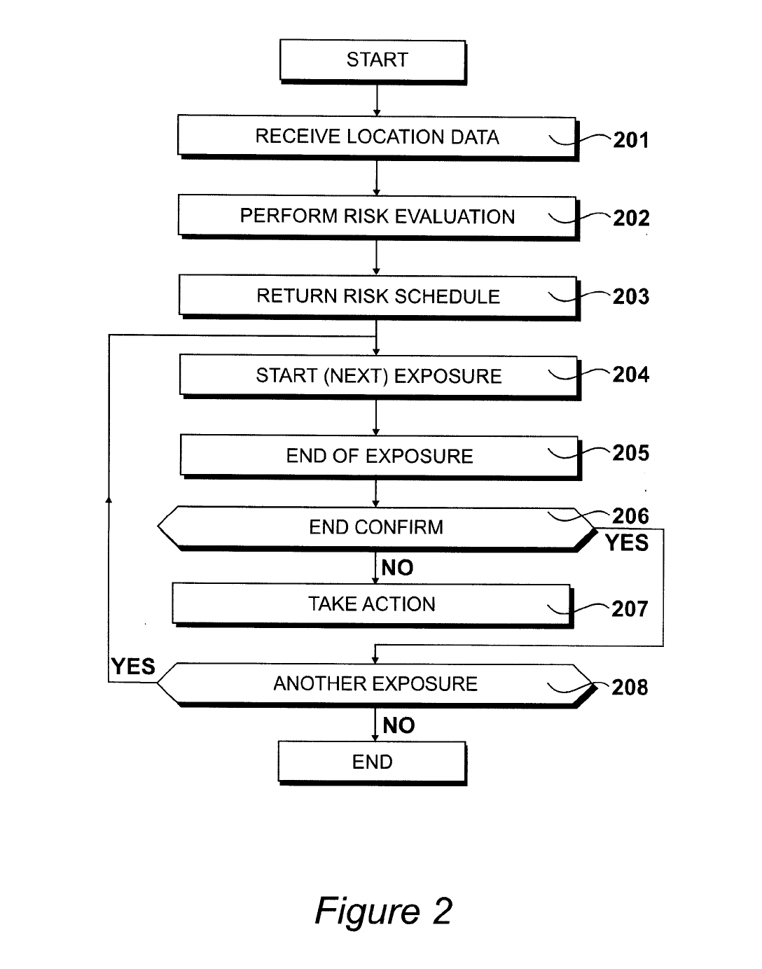

### FIG. 2

Operations performed by the server system 101 are identified in FIG. 2. At step 201 location data is received from a transmitting remote device, such as computer 104. At step 202 a risk evaluation is performed and a risk schedule is returned at step 203.

The server system 101 includes a scheduling process such that work activities have a predetermined start time and a predetermined end time that in turn may create scheduled events.

At step 204 a work exposure starts and at step 205 the exposure (which started at step 204) should have ended. This event is scheduled such that shortly thereafter a question is asked at step 206 as to whether a confirmation has been received from the lone worker to the effect that the exposure has completed. Thus, having finished the exposure, the lone worker will be required to submit a text, an email or other communication to the server, indicating that an exposure has been completed. Alternatively, the server itself may issue a communication and the lone worker will be required to acknowledge this communication thereby confirming that the exposure was successfully completed.

If the end of the exposure is successfully confirmed at step 206, a question is asked at step 208 as to whether another exposure is to take place resulting in the next exposure being selected at step 204. Thus again, the end of the exposure will be identified and a question will be asked at step 206 as to whether the end has been confirmed.

If the end is not confirmed back to the server, resulting in the question asked at step 206 being answered in the negative, appropriate action is taken at step 207.

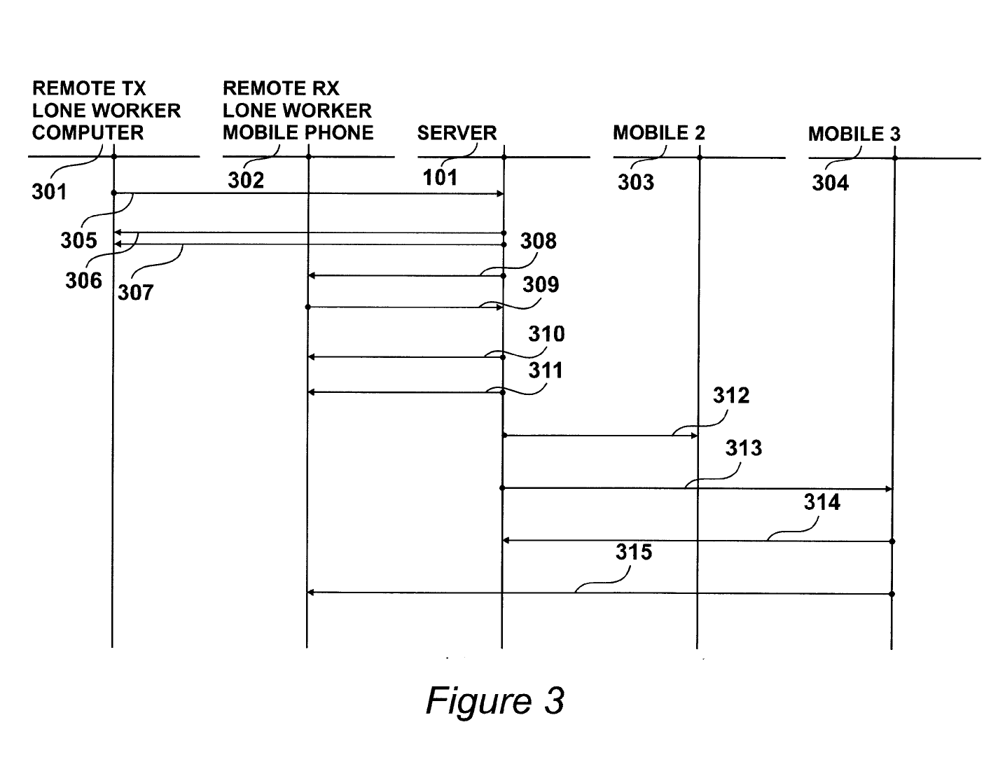

### FIG. 3

In an embodiment, when the server system 101 takes action, in response to a failure to receive a confirmation to the effect that an exposure has not successfully completed, the server computer will seek to established communication with a co-worker of the lone worker concerned. In an embodiment, a communication to a lone worker is made by an audio call or a text message to the mobile phone of the co-worker. Furthermore, if appropriate, the action may escalate to contact being made to a second co-worker and, again where appropriate, the action may further escalate where attempts are made to contact a group of co-workers. It is therefore envisaged that a group of workers would co-operate as a “cohort”, whereupon each of the workers in the group may act as a “buddy” to other members of the group.

A protocol diagram for procedures performed within the environment of FIG. 1 is illustrated in FIG. 3. A transmitting remote device for the lone worker is identified at 301. A remote receiving device for the lone worker is shown at 302. As previously described, the transmitting remote device may be a personal computer and the receiving remote device may be a mobile cellular telephone. Alternatively, both functions may be provided by an enhanced mobile communications device.

Server 101 is indicated, along with a second mobile device 303 and a third mobile device 304. Mobile device 303 may be in the possession of a first co-worker and mobile device 304 may be in the possession of a second co-worker.

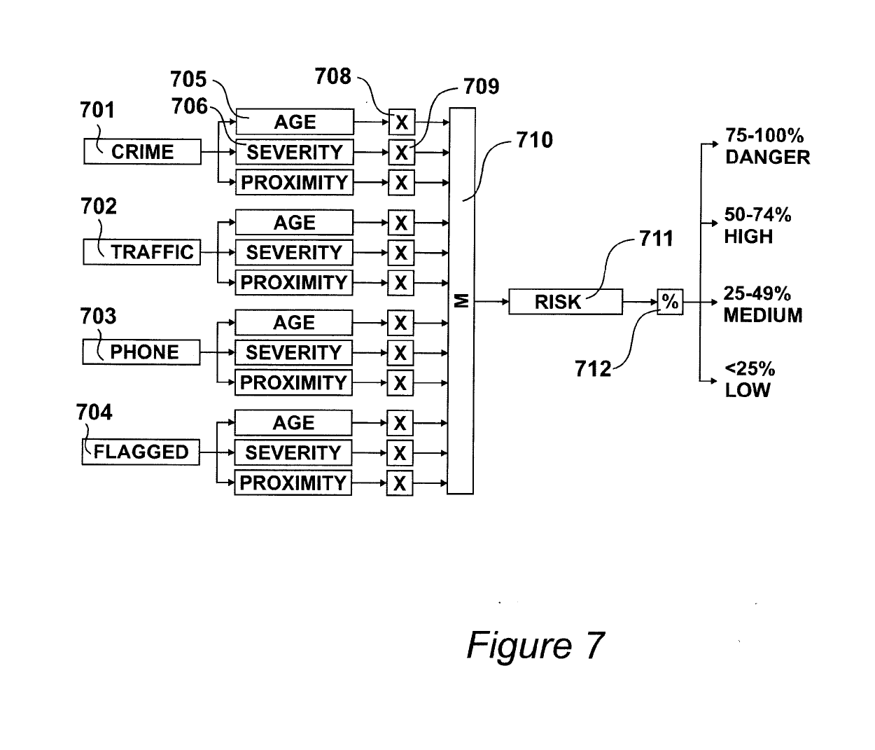

At 305 the lone worker conveys location data to the server 101. The server 101 returns risk related data for the locations at 306; and as detailed in FIG. 7. At 307 the server 101 returns an enhanced schedule, reflecting the scheduled data retained within the server system 101.

After a period of time, the first exposure will start, as indicated at 204 and after a specified period of time the exposure will end. The server system will then expect a confirmation to be received to the effect that the exposure has been completed.

In this example, if the lone worker fails to pro-actively notify the server, the server 101 issues a request 308 to the mobile cellular telephone 302 of the lone worker. In this example, as indicated at 309, the lone worker acknowledges this prompt, resulting in the question asked at step 206 being answered in the affirmative and the next exposure being selected at step 208.

Upon completion of the next exposure, the server system 101 again issues a request 310 to the lone worker for confirmation to the effect that the exposure has been completed successfully. In this example, for the purposes of illustration, it is assumed that on this iteration the lone worker fails to respond. Consequently, a further request 311 is issued by the server to the lone worker's mobile cellular telephone 302 for confirmation to the effect that the exposure has been completed successfully.

For the purposes of this illustration, it is assumed that the lone worker fails to respond to the second request 311. In this example, this results in an escalation; such that the server 101 is required to take further action. Consequently, as illustrated at 312, the server 101 now contacts the first co-worker 303. For the purposes of this illustration, it is assumed that co-worker 303 fails to respond; their mobile phone may be switched off or they may have lost signal.

Having failed to receive a response from co-worker 303, a further escalation of concern occurs at the server 101, resulting in a communication 313 to the second co-worker 304. For the purposes of this illustration, the second co-worker 304 makes a response, as illustrated at 314, back to the server 101 and any possibility of further escalation occurring at the server is terminated.

Thus, having received and acknowledged a communication from the server to the effect that the lone worker 302 may be in trouble, the second co-worker 304 contacts the lone worker by mobile phone, as illustrated at 315.

Having made this communication, the onus is now on the second co-worker to determine the status of lone worker 302. However, in an embodiment, the server system will continue to monitor the situation in anticipation of receiving a notification from the original lone worker.

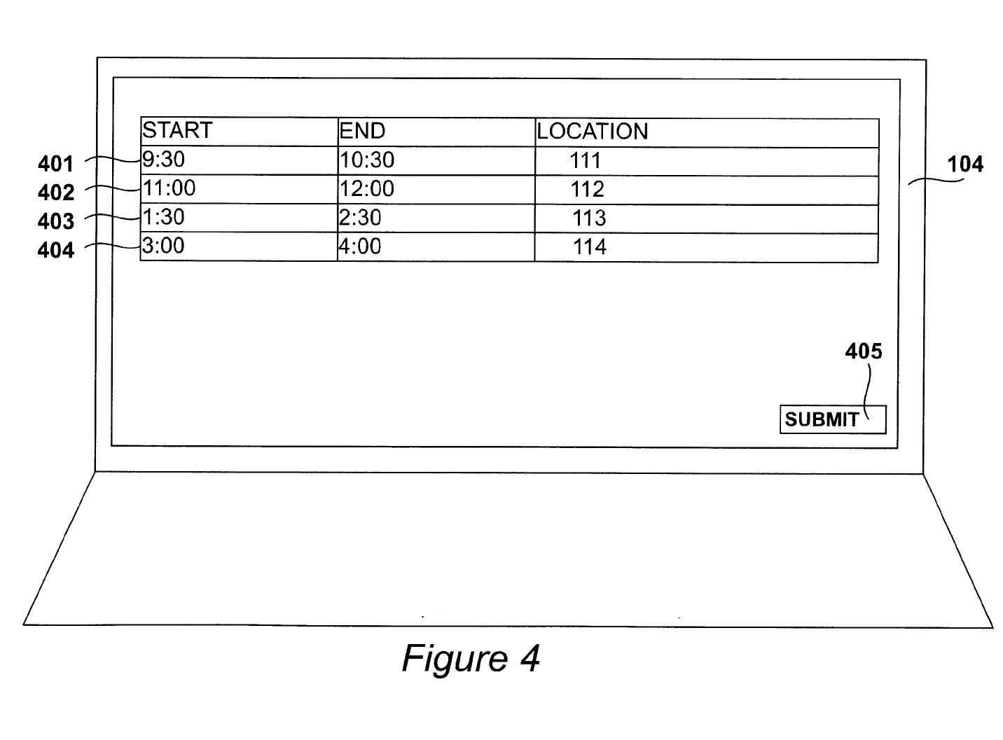

### FIG. 4

In an embodiment, the server system 101 receives location data from laptop computer 104, as illustrated in FIG. 4.

In this example, for a particular day, a lone worker has scheduled a first event 401, a second event 402, a third event 403 and a fourth event 404.

For the purposes of this illustration, the first event is scheduled to start at 9.30 and finish at 10.30 at location 111. Similarly, the second event 402 starts at 11.00, finishes at 12.00 noon and takes place at location 112.

The third event 403 starts at 1.30, ends at 2.30 and takes place at location 114. Similarly, the fourth event 404, taking place at location 114, starts at 3.00 pm and ends at 4.00 pm. Thus, having entered this information, the lone worker activates “submit” button 405 which conveys the data (as illustrated at 305) to the server 101.

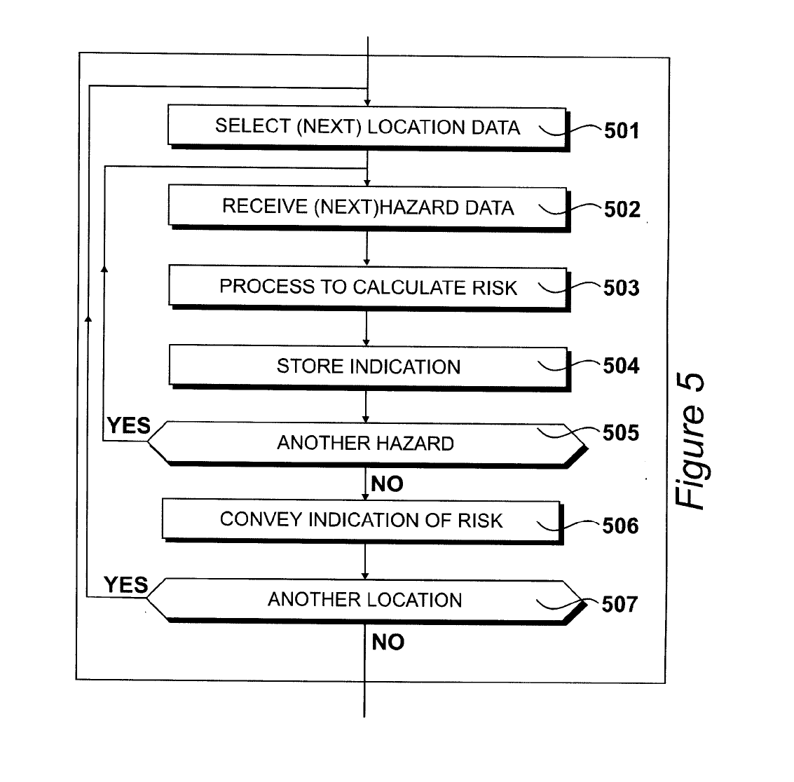

### FIG. 5

Procedures 202 for performing a risk evaluation are detailed in FIG. 5. The risk evaluation process makes reference to the scheduled data previously submitted, as detailed in FIG. 4. It also makes reference to hazard data from external sources 119, 120 and 121, along with locally generated hazard data.

At step 501 a location data item is selected, which on the first iteration would be location 111.

At step 502 hazard data may be selected which, for the purposes of this example, may be hazard data from data source 119. At step 503 the hazard data, referencing the location data, is processed to calculate an indication of risk. At step 504 the indication of risk is stored and at step 505 a question is asked as to whether another hazard source is to be considered. On the first iteration, the question asked at step 505 will be answered in the affirmative, resulting in the next hazard data, from source 120, being selected at step 502. Again, a risk value is calculated and stored and the process continues until all of the hazard sources have been considered. Thereafter, an indication of risk is conveyed at step 506 and a question is then asked at step 507 as to whether a further location is to be considered. When answered in the affirmative, the next location data will be selected at step 501, thus, for the purposes of this example, location 112 would then be selected. The risk calculations are again performed for this location and the process continues until location 113 and location 114 have been considered.

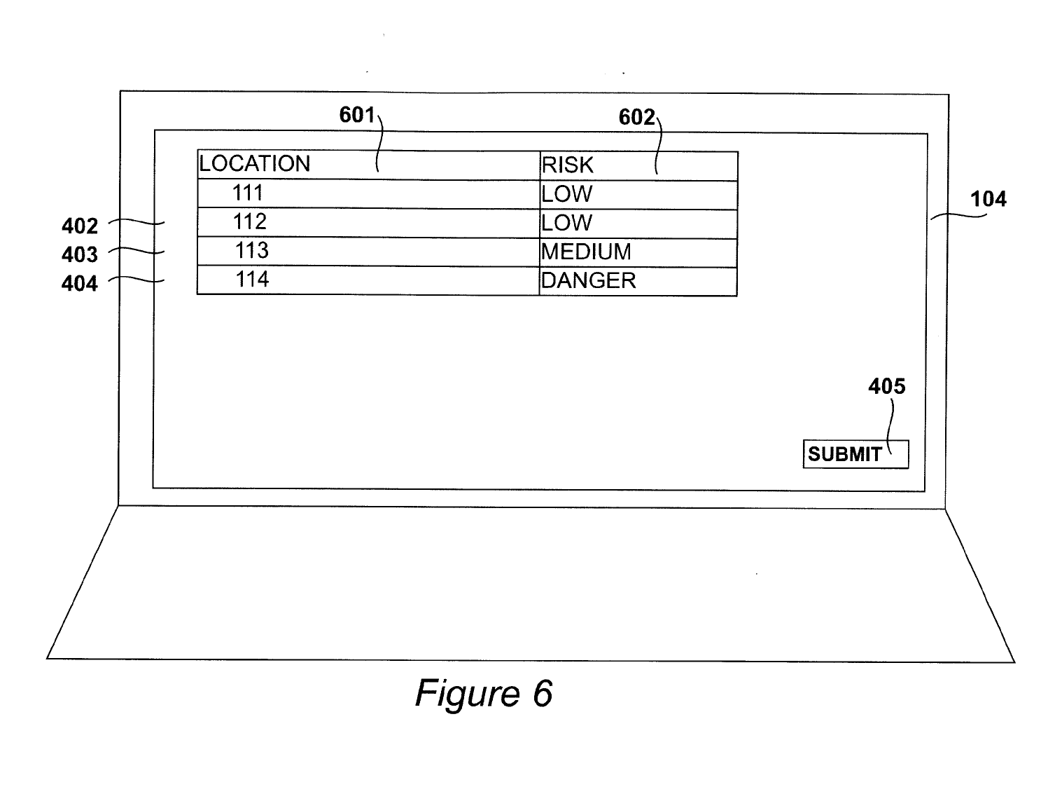

### FIG. 6

As illustrated in FIG. 6, indications of risk may be conveyed back to mobile computer 104, in the form of a table.

A first column 701 identifies the locations and a second column 702 identifies an indication of calculated risk. Thus, for the purposes of this example, locations 111 and 112 have been given a low risk value, location 113 has been given a medium risk value and location 114 has been given a danger value.

It has been estimated that there are between two million and four million people working alone in the United Kingdom, each being exposed to attack, verbal abuse and incapacitation. Of these, it has been suggested that only one hundred and fifty thousand to one hundred and eighty thousand have been provided with dedicated equipment to raise an alarm should a danger situation be encountered. The present invention provide technical back up to lone workers using equipment that is readily available to them as an alternative to dedicated equipment provided by their employer.

At the completion of a scheduled event, the lone worker should contact the server system to confirm that they did not experience any difficulties. However, if the server system does not receive this call after a predetermined time, it will endeavour to make contact with the lone worker.

Furthermore, in some embodiments, if it is not possible to contact the lone worker, a first co-worker and then possibly a second co-worker etc will be contacted. Thus, the technical overhead is minimal but the automated system ensures that there are no weak links in terms of being reliant upon a co-worker remembering to make contact when they have not received confirmation of a satisfactory completion.

A present embodiment sends messages from the server to the lone worker at times when a visit is expected to be over or when the lone worker is expected to be back at home. These messages ask the lone worker to confirm that they have completed the visit.

If the lone worker does not respond, the system will send escalation messages to specified points of contact. In an embodiment described herein, messages are conveyed by mobile telephony. However, in an alternative embodiment, escalation emails may be sent to specified points of contact. Thus, if a first allotted “buddy” does not respond within a specified period time of, say ten minutes, the system will move on to the second buddy and third buddy etc until, hopefully, a response has been received.

As illustrated in FIG. 6, based on where a lone worker is going, the server system 101 automatically sends data, which could be in the form of an email, identifying the risk profile of the location. Thus, this data could be conveyed to the lone worker one hour, say, before the start of the first event. Thus, in the current illustration, the events could be scheduled some time in advance but the risk data would be conveyed to the lone worker at 9.00 am.

Co-workers create a community of, say four or five colleagues engaged in similar activities. If anyone in this community has a particular experience (which may be good or bad) the system allows them to make an entry of a tagged risk. This can then be included in risk profile data sent to other co-workers in the community. To be compatible with other forms of data processed within the system, all tagged data should relate to a specific location; which also has the advantage of removing the possibility of making reference to specific individuals.

In an extension of the service, it would be possible for individual groups to share information and, in particular, data may be recorded that is relevant to the risk profile but at the same time would not be of a level severe enough to be brought to the attention of the authorities, including the police.

It is possible for the risk evaluations to be presented in many ways but ultimately the presentation should allow the individual lone worker to make their own risk assessment. A risk score is entered but a lone worker must decide whether they have the necessary training or otherwise to accommodate the level of risk. For example, inexperienced workers may be encouraged to make visits of low or medium risk that avoid anything above. Experienced workers could, for example, be in a position to experience high risk. However, for danger situations or very high risk a policy decision may be taken to the effect that visits by a single individual should be avoided.

In an implementation, at the server system 101 computers and mobile devices accessing the system feed data to a web application. The back end communicates with an SQL database and receives external feeds from the data sources 19, 120 and 121. in an embodiment, these consists of police data, interfacing with the police API in the United Kingdom (119), the NTCC providing European traffic data (120) and data from mobile networks relating to outages (121).

As previously described, the user has identified an itinerary of visits, with each visit occurring at specific location and over a predetermined time interval. As a result, the server system 101 is required to perform actions at scheduled times. These actions are supplied to a scheduler and the scheduler picks up an itinerary item and from this it is identified that it must identify hazards, such as from crime related data, for that particular location.

When a location is specified, a latitude and longitude grid reference may be generated. This may be passed as a call to the police API service 119 from which details of the local constabulary are returned. From this, it is possible to obtain crime data for the particular constabulary. Thus, the data identifies a number of robberies, violent crimes and vehicular crimes being investigated within the region.

A similar procedure is performed for the NTCC 120. In an embodiment, the entire database is downloaded every ten minutes. This provides details of all road traffic incidents, planned and unplanned. Again, a similar procedure is performed for the mobile networks 121 which again include planned and unplanned events.

To evaluate the data, a process substantially similar to geo-fencing in performed. Under these procedures, the information is supplied to a quad-tree and queries are subsequently directed at this within the database. Thus, it is possible to obtain information that is a specified distance away form a particular location.

### FIG. 7

In an embodiment, the hazard data is read from data sources 119 to 121 which may include a selection of one or more of crime data 701, road traffic data 702 and mobile telephony availability data 703. In addition to this, tagged data 704 is also included, being history of events recorded by the users themselves.

In this example, for each data type, a score is derived that may be considered as hazard components which again may include a selection of one or more of the age of the hazard, the severity of the hazard and the proximity of the hazard to the location under consideration.

Thus, from the crime data and making reference to a specific geographical location, a risk score is 705 is generated, based on the age of the crimes. Thus, if the crimes in question took place along time ago, a relatively low score is given. Similarly, a higher score is given if the crimes took place relatively recently. In an example, a score may be given over a range of one to five. A similar score 706 is derived from the severity of the crimes. In an example, severity values may range from one to three. A third score 707 may be derived in relation to the proximity of the crime. Thus, a collection of concentric circles may be identified of varying radii centred around the specific location. In this way, it is possible to quantise values of proximity; possibly ranging from a value of five for a very close crime to a value of one for a crime some distance away.

As illustrated in FIG. 7, these hazard components of age, severity and proximity are also derived from the traffic data 702, the mobile phone data 703 and the flagged data 704. Based on empirical evidence, appropriate ranges are specified for each of the hazard components.

It is also appreciated that some hazard components will have a greater bearing on risk than others. In an example, flagged hazard components may be given a relatively high rating, given that they are particularly relevant for the work being conducted and are based on personal experience. Similarly, crime data may be given a higher waiting compared to components derived from traffic conditions.

To take account of these waiting's, each risk component 705, 706 etc is processed in combination with a respective coefficient. Thus, the age component 705 is processed with a coefficient 708 and severity component 706 is processed in combination with a second coefficient 709 and so on. Thus in the example shown in FIG. 7, there are a total of twelve coefficients each being processed in combination with their respective risk component. Again, the exact value of these coefficients will be determined over a period of time based on empirical evidence.

As shown at 710, the output from each component calculation is combined and preferably summed so as to provide a risk value 711. In an embodiment, this risk value is then normalised in order to generate a percentage 712. Furthermore, in the embodiment, the percentage values are then quantised. In this example, for percentage values below twenty-five percent a low risk is specified, for percentage values of twenty-five percent to forty-nine percent a medium value is specified, for percentage values of fifty percent to seventy-four percent a high value is specified and for percentage values of seventy-five percent to a hundred percent a danger level is indicated.

The processing step 503, in an embodiment, consists of collecting the hazard data as a plurality of hazard components. These hazard components are manipulated in combination with respective weighting values to produce weighted components. Furthermore, the weighted components are combined to produce a calculation of risk.

In an embodiment, this calculation of risk is normalised to produce an indication of risk, which, in an embodiment, may be represented as a percentage. Furthermore, in an embodiment, the indication of risk is quantised and in an embodiment the quantised levels may comprise low, medium, high and danger.

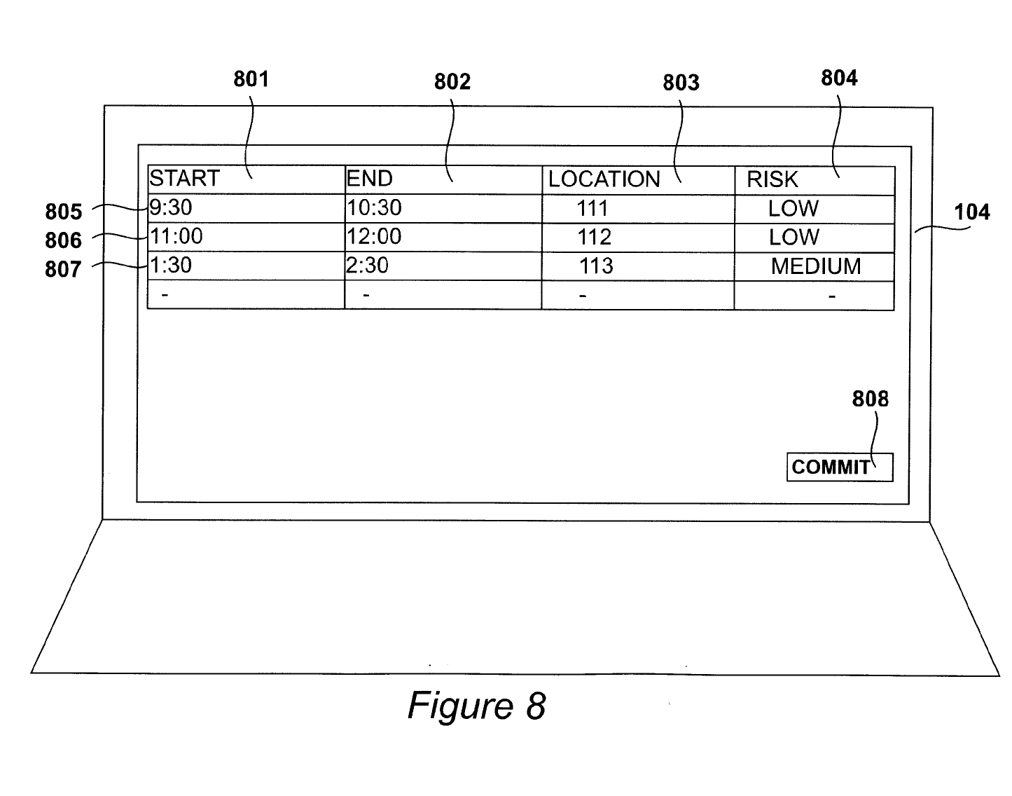

### FIG. 8

As previously described, the lone worker has been presented with an indication of risk for each of the locations 111 to 114 and the lone worker must now make their individual risk assessment to determine whether it would be appropriate to continue and whether any additional action is required. The server system 101 is also aware of the calculated risk and in an embodiment action taken by the server system may be modified in response to the risk calculations made.

On the assumption that the user wishes to continue, the lone worker activates “schedule” button 601 resulting in the generation of a schedule as indicated in FIG. 8. As seen in FIG. 8, the schedule is effectively a combination of the data supplied to the system in combination with the calculated risks. Thus, a first column 801 identifies a start time, a column 802 identifies an end time, a location is identified in column 803 and a risk calculation is included in column 804.

For the purposes of this example, entries 801, 802 and 803 are derived from entries 401 to 403 of FIG. 4. However, entry 404 has resulted in an identification of a risk level “danger” therefore the lone worker has made their risk assessment and decided that they lack the appropriate qualifications to attend this visit. Consequently, the visit has been cancelled and alternative measures will be required.

In the example shown in FIG. 8, the user interface includes a “commit” button 808. Thus, activation of this button confirms a commitment to attend the visit specified in the schedule.

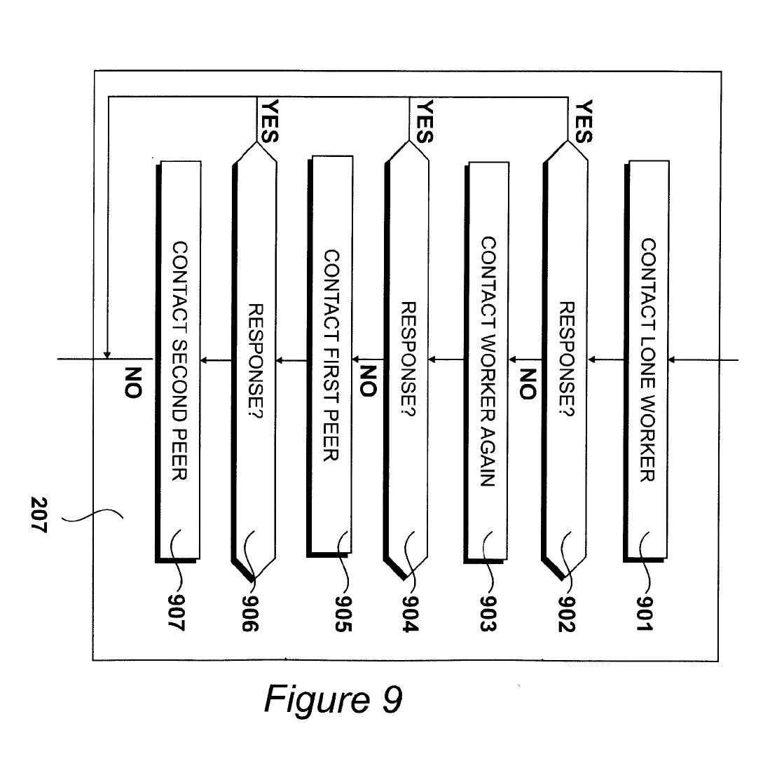

### FIG. 9

Every user (lone worker) of the group effectively has a list of safety buddies. On detecting that a lone worker may be in trouble, the system selects the first buddy and checks whether they are available. In an embodiment, it will then ask again in ten minutes, and again if there is no response, it will select the next one and so on until an available co-workers have been identified. The located co-worker should then respond to the effect that they are looking into the matter.

In an embodiment, if a user does not respond, the action may be marked as being active. If a buddy responds, the action is marked as being on hold and when a user confirms their safety, it is then marked down as cancelled. If no one responds, a message may be broadcast to all members in the group. In alternative embodiments, it may be possible to take further action, such as contacting authorities. However, when such a level of protection is required, it may be preferable to provide employees with dedicated equipment, so as to ensure a faster response.

An example of procedure 207, taking action when a lone worker may be in danger, is detailed in FIG. 9. In response to the question asked at step 206 being answered in the negative, an attempt is made at step 901 to contact the lone worker. At step 902 a question is asked as to whether a response has been received and the action is cleared if answered in the affirmative.

If the question asked at step 902 is answered in the negative, a further attempt is made to contact the lone worker at step 903. Again, a question is asked at step 904 as to whether a response has been made and again if answered in the affirmative the action is cleared.

In response to the question asked at step 904 being answered in the negative, a first peer, co-worker or “buddy” is contacted at step 905. At step 906 a question is asked as to whether a response has been received from the first peer and if answered in the affirmative, the action is cleared. As previously described, further actions may be included to check that a response is ultimately received from the lone worker.

If the question asked at step 906 is answered in the negative, a second peer is contacted at step 907. In this example, no further action is taken if it is not possible to contact the second peer. Thus, the available degrees of escalation may vary depending upon a particular implementation.

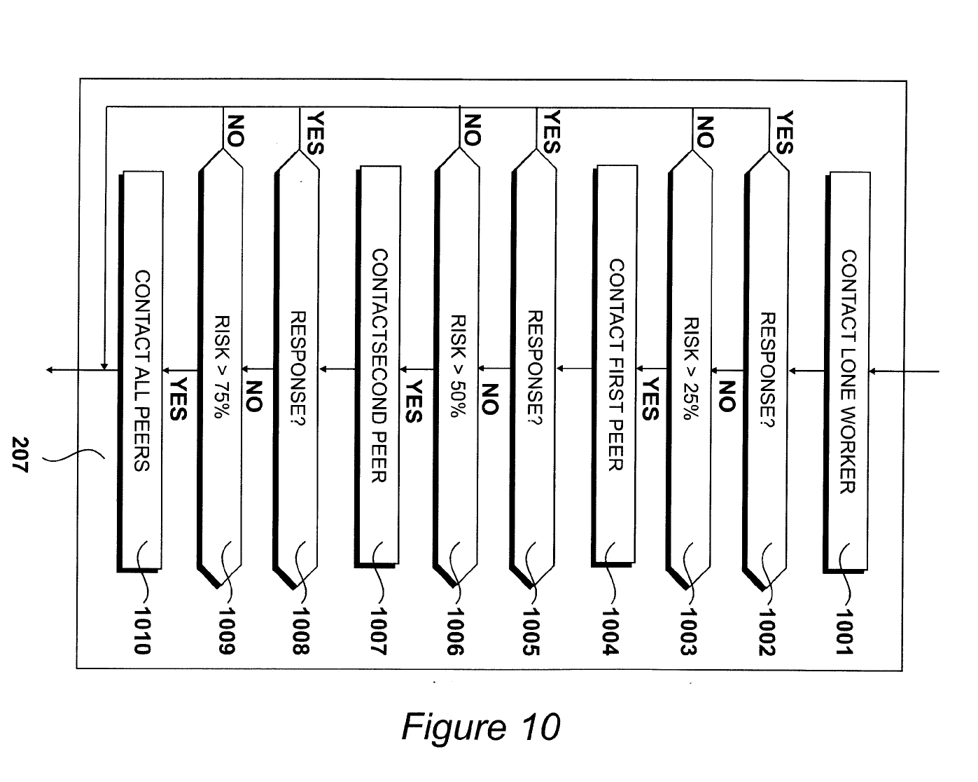

### FIG. 10

In a first implementation, communication between members of the group is achieved primarily via the mechanism of electronic mail. An advantage of this approach is that there are no communication costs and it is therefore not necessary to demand a monthly payment in order to maintain the service.

In the embodiment described with reference to FIG. 1, an intermediate position may be adopted in which communications are achieved by electronic mail and communications generated in response to identifying a potentially dangerous incident may be communicated via mobile telephony or SMS text messages.

In a further enhancement, as suggested by device 107, communication could take place exclusively within a mobile device environment and specific applications, “apps”, could be developed to provide enhanced services supported by mobile platforms.

In an enhanced example, it may be possible for a level of action to be selected by the server computer system based on the calculated assessment of risk. An enhanced proposal for procedures 207, is identified as 207′.

The procedure starts from the question asked at step 206 being answered in the negative, to the effect that a lone worker has not confirmed that an interaction has finished. Thus, at step 1001 an attempt is made to contact the lone worker.

At step 1002 a question is asked as to whether a response has been received and if answered in the affirmative the process clears. If answered in the negative, it may be necessary to take further action. However, before taking this action, a question is asked so as to assess the level of previously calculated risk. Thus, at step 1003 a question is asked as to whether the calculated risk for the encounter was greater than twenty-five percent. If the risk was calculated as being below twenty-five percent, this will have been considered to be a low level of risk and as such it is more likely that the lone worker has forgot to respond rather than having encountered a dangerous situation. Thus, if the question asked at step 1003 is answered in the negative, no further action is taken.

If the question asked at step 1003 is answered in the affirmative, meaning that the level of calculated risk is greater than twenty-five percent, the first peer, co-worker or “buddy” is contacted at step 1004.

Again, a question is asked at step 1005 as to whether a response has been received and if answered in the affirmative the situation is cleared.

If the question asked at step 1005 is answered in the negative, to the effect that a response has not been received from the first co-worker, further action may be taken but again this is dependent upon the previously calculated level of risk.

Thus, at step 1006 a question is asked as to whether the previously calculated level of risk is greater than fifty percent. If this question is answered in the negative, the previously calculated level of risk only represented a medium level of risk therefore no further action is taken.

If the question asked at step 1006 is answered in the affirmative, to the effect that the previously calculated level of risk was greater than fifty percent, a second co-worker is contacted at step 1007.

At step 1008 a question is asked to whether a response has been received and again if answered in the affirmative, the situation is cleared. If a response has not been received from the second co-worker, resulting in the question asked at step 1008 being answered in the negative, further action may be taken but again based on the previously calculated level of risk.

At step 1009 a question is asked as to whether the previously calculated level of risk was greater than seventy-five percent, representing a potentially dangerous situation. Thus, if the question asked at step 1009 is answered in the affirmative, all of the co-workers are contacted at step 1010. Alternatively, if the question asked at step 1009 is answered in the negative, the situation is cleared.

Again, the preferred level of escalation may be variable dependent on particular implementation attributes. Similarly, the extent to which risk is considered is also variable and will again depend upon particular implementations.

In an alternative embodiment, it may be possible for the system to be more proactive in higher risk areas. Furthermore, when implemented as a mobile device application, it would be possible for the application to communicate with the user's calendar and the Global Positioning Satellite (GPS) receiver contained within the mobile device. Thus, it will be possible for the mobile device to communicate with the server system reporting back as to where the user is located. Thus, using the techniques describe herein, it would be possible for the risk level to be re-assessed with specific reference to the identified location of the user and a decision could then be made as to whether the user, co-workers or the authorities should be notified.

In an implementation, each of the events of escalation is encapsulated by an event that needs scheduling for a particular date and time. When an event is scheduled for a particular time, this may result in the generation of an email or alternative communication to confirm a lone worker's safety. The action may be retained in a database table and it may then create an alert to go off in, say, ten minutes if the initial event has not has resulted in a cancellation. Thus, as questions are raised in the logic as previously described, new events may be created for the scheduling process.

In an example, a checkpoint may be scheduled at, say 12.30. In response to this, at 12.40, an alert is scheduled which will remain present unless cancelled by the lone worker. In an implementation, escalation is achieved by calls to URL's from the scheduler. Thus, the application creates a new record in the table which the scheduler then picks up in ten minutes time.

In an implementation, the scheduler will only bring events to the attention of the process within a two to three minute guard window. The process itself will interrogate the situation every minute, say, so as to identify what needs to be done over the next two minute window.

1. A method of operating a server computer system configured to communicate with a plurality of remote devices, in which said remote devices are operated by lone workers exposed to hazardous environments, said method comprising the steps of:
receiving location data identifying a work location from a transmitting remote device;
receiving hazard data relating to hazards in the vicinity of said work location;
processing said hazard data to produce an assessment of risk; and
conveying an indication of said assessment of risk to a receiving remote device.

2. The method of claim 1, wherein said transmitting remote device is a personal computer system.

3. The method of claim 1, wherein said location data is received as an itinerary items identifying one or more work locations to be visited over a period of time.

4. The method of claim 3, wherein each said itinerary item identifies an end-time, being a time at which the respective visit should have been completed.

5. The method of claim 4, wherein said server computer system seeks further input at a predetermined period after said end-time.

6. The method of claim 5, wherein said server computer system seeks said further input from the respective receiving remote device.

7. The method of claim 5, wherein said receiving remote device is a mobile cellular telephone.

8. The method of claim 5, wherein said server computer system takes escalated action if said further input is not received.

9. The method of claim 8, wherein a first level escalated action involves attempting to contact the lone worker again.

10. The method of claim 8, wherein a second level of escalated action involves attempting to contact a first co-worker.

11. The method of claim 10, wherein a third level of escalated action further involves attempting to contact a second co-worker.

12. The method of claim 11, wherein a fourth level of escalated action further involves attempting to contact a group of lone workers.

13. The method of claim 8, wherein a level of action is selected by the server computer system based on said calculated assessment of risk.

14. The method of claim 1, wherein said hazard data is read from data sources including a selection of one or more of the following, comprising: historical crime data, road traffic data and mobile telephony availability data.

15. The method of claim 14, wherein one or more of said hazard data includes hazard components including a selection of one or more of the following, comprising: age, severity and proximity.

16. The method of claim 14, wherein said proximity hazard components are determined with reference to a geo-fence quad-tree.

17. The method of claim 1, wherein said processing step includes:
collecting said hazard data as a plurality of hazard components;
manipulating said hazard components in combination with respective weighting values to produce weighted components; and
combining said weighted components to a produce an assessment of risk.

18. The method of claim 15, wherein said assessment of risk is normalised to produce said indication of risk.

19. The method of claim 1, wherein said indication of risk is quantised.

20. The method of claim 19, wherein said quantised levels of risk comprise: low, medium, high and danger.
